(19) United States
(12) Patent Application Publication
(10) Pub. No.: US 2025/0023072 A1
(43) Pub. Date: Jan. 16, 2025

(54) OPERATING STRATEGY FOR THE SHORT-CIRCUIT START OF FUEL CELLS WITH EXCESS AIR

(71) Applicant: Robert Bosch GmbH, Stuttgart (DE)

(72) Inventor: Helerson Kemmer, Vaihingen (DE)

(21) Appl. No.: 18/700,324

(22) PCT Filed: Oct. 12, 2022
(86) PCT No.: PCT/EP2022/078379

§ 371 Date: Apr. 11, 2024

(30) Foreign Application Priority Data
Oct. 14, 2021 (DE) 10 2021 211 602.7

(51) Int. Cl. H01M 8/04302; H01M 8/04858

(52) U.S. Cl. CPC H01M 8/04302; H01M 8/0491; H01M 2250/20

(57) ABSTRACT

The invention relates to a method for operating a fuel cell system (100) comprising at least one stack (101) when starting the fuel cell system (100), in particular when starting the fuel cell system (100) under freezing conditions, in order to bring a short-circuit current (I) through the stack (101) to a desired target value (I1), comprising the following steps:
initiating a start under freezing conditions,
short-circuiting the stack (101),
increasing a rotational speed (N) of a compressor (12) in a cathode system (10) of the stack (101) until the short-circuit current (I) has exceeded the desired target value (I1), wherein during the increase of the rotational speed (N) of a compressor (12) an excess of air mass flow (dm2/dt−dm1/dt) is permitted in a targeted manner,
reducing the rotational speed (N) of the compressor (12) until the short-circuit current (I) has reached the desired target value (I1), wherein during the reduction of the rotational speed (N) of the compressor (12) the excess of air mass flow (dm2/dt−dm1/dt) is reduced.

### BACKGROUND

The invention relates to a method for operating a fuel cell system comprising at least one stack when starting the fuel cell system, in particular when starting the fuel cell system under freezing conditions in order to bring a short-circuit through the stack to a desired target value. The invention further relates to a corresponding control unit and a corresponding computer program product.

Fuel cells are regarded as the mobility concept of the future because they only emit water as exhaust gas and enable fast refueling times. Fuel cells are usually stacked to form a stack. A fuel cell system can comprise at least one or more stacks. Fuel cells need air and fuel, e.g. hydrogen, for the chemical reaction. The waste heat from the stack is dissipated by means of a coolant circuit and released into the environment via a vehicle cooling means.

The hydrogen enters the anode from a tank via a pressure reducer and blow-in valve via a suction jet pump. The suction jet pump recirculates the gas mixture. The air is supplied by an electrical air compressor. The air mass flow through the stack is usually measured by means of an air mass flow sensor.

A short-circuit relay can be provided in the electrical circuit. The stack is thereby short-circuited in certain cases (anode loading, start, . . . ). The short-circuit current is usually sensed via the current sensor.

When starting under freezing conditions, the stack can be warmed up very quickly. During the short-circuit, the electrical current is directly proportional to the air mass flow; therefore it is limited to prevent excessive currents. This can result in the air mass flow being too low and its distribution among the cells being no longer homogeneous. This can have destructive effects under short-circuit conditions with a wide spread of cell voltages. If some cell voltages become (deeply) negative, then they degrade irreversibly.

### SUMMARY

The present invention relates to a method for operating a fuel cell system comprising at least one stack when starting the fuel cell system, in particular when starting the fuel cell system under freezing conditions in order to bring a short-circuit through the stack to a desired target value, said method having the features of the disclosure. The invention further provides a corresponding control unit and a corresponding computer program having the features of the disclosure. In this context, features and details described in connection with the various embodiments and/or aspects of the invention clearly also apply in connection with the other embodiments and/or aspects of the invention, and respectively vice versa, so, with respect to the disclosure, mutual reference to the individual embodiments and/or aspects of the invention is or can always be made.

According to a first aspect, the present invention relates to a method for operating a fuel cell system comprising at least one stack when starting the fuel cell system, in particular when starting the fuel cell system under freezing conditions in order to bring a short-circuit through the stack to a desired target value.

The method comprises the following actions:
initiating a start under freezing conditions,
short-circuiting the stack,
increasing a rotational speed of a compressor in a cathode system of the stack until the short-circuit current (meaning the electrical current through the stack in the event of a short-circuit of the stack) has exceeded the desired target value,
whereby during the increase of the rotational speed of the compressor, an excess of air mass flow excess is permitted in a targeted manner,
whereby in particular with the permitted excess of air mass flow and under consistent ambient conditions, such as a constant temperature, a higher value of the short-circuit current than the desired target value could be achieved,
reducing the rotational speed of the compressor until the short-circuit current has reached the desired target value,
whereby during the reduction of the rotational speed of the compressor, the excess of air mass flow is reduced,
whereby in particular such an air mass flow is readjusted, which under consistent ambient conditions, such as consistent temperature, corresponds to the desired target value of the short-circuit current.

The method steps according to the invention can be performed in the specified order, or in an amended order. The method steps according to the invention can be performed simultaneously, at least in part concurrently, and/or sequentially.

The fuel cell system within the meaning of the invention can preferably be used for mobile applications, e.g. in vehicles, in particular fuel-powered vehicles. The fuel cell system within the meaning of the invention can be used as the main energy source for an electric motor of the vehicle. At the same time, however, it is also conceivable that the fuel cell system within the meaning of the invention can be used as an energy provider for a slave drive and/or an auxiliary drive of a vehicle, e.g. a hybrid vehicle. The fuel cell system within the meaning of the invention can also be used for stationary applications, e.g. in generators.

The fuel cell system within the meaning of the invention can in this case comprise one or more stacks each having multiple stacked fuel cells and the associated functional systems comprising: media systems (air or cathode system, fuel or anode system, cooling system), as well as an electrical system. Preferably, the fuel cell system within the meaning of the invention can comprise multiple modules in the form of individual stacks having multiple stacked fuel cells.

The invention recognizes that if the short-circuit current is not selected as high for stack and system protection reasons, the corresponding air mass flow is also not so high. This can cause the distribution of the air mass flow among the fuel cells to be non-homogeneous. As a result, the fuel cells receive different air supplies. Given that the short-circuit current across all fuel cells is the same, this results in different voltages at the cell level (at the stack level the voltage remains at “zero”). Some fuel cells will even have negative voltages, which can lead to undesirable electrochemical reactions, along with accompanying degradation.

If the air mass flow is too low, then the availability of oxygen within the fuel cells is also impaired, in particular in the outlet area of the cells. As the catalytic converter area of the fuel cells is partially covered with ice when starting under freezing conditions, a reduced supply of oxygen has an even worse effect on cell performance. As a result, a proton pump reaction is more likely to take place in certain areas of the cells (in particular in the outlet area), with correspondingly low heat generation. The result is an increased risk of icing.

Furthermore, the low air mass flow will not be able to distribute the generated heat to the desired extent, in particular if the coolant cannot perform this task (either because the coolant pump has not yet been turned on or the high viscosity of the coolant caused by the low temperatures results in the volume flow being very low).

On the other hand, the invention recognizes that the real short-circuit current may initially be lower than expected if the fuel cell temperature is still very low (in the range of temperatures under freezing conditions, which may be below −4° C., or even much lower, e.g. below −20° C.). If a certain air mass flow is set but the fuel cell temperature is still very low, then the short-circuit current will not immediately assume a desired target value that can be reached at the certain air mass flow. As the temperature increases, the short-circuit current increases to the target value. If the temperature is increased further, the short-circuit current remains at the set target value due to the limited air mass flow with the constant air mass flow.

The invention proposes to use this effect so that the short-circuit current increases somewhat slower at low temperatures than the air mass flow. If the air mass flow has already reached the determined value, then the short-circuit current increases with a time delay caused by the low temperatures until reaching the desired target value.

The invention proposes first adjusting the air mass flow higher than the determined air mass flow for the desired target value of the short-circuit current so that excess air can be provided. The air mass flow can then be lowered again from the higher value to the determined air mass flow and the short-circuit current can then be set to the desired target value.

In the context of the invention, the stack is first short-circuited when starting under freezing conditions. The rotational speed of the compressor is then increased with a consequent increase in the air mass flow. The electric current or the short-circuit current initially increases proportionally to the air mass flow until it is limited by the thermal properties of the cells. The electric current then increases gradually by heating the cells. As long as the target value of the short-circuit current has not yet been exceeded, the air mass flow is further increased, preferably up to a maximum threshold value, which may be significantly higher than the determined air mass flow for the target value of the short-circuit current. If this maximum threshold value of the air mass flow is reached, it can be kept constant until the electric current exceeds the target value. If this is the case, the air mass flow or the air compressor rotational speed is reduced until the electrical current reaches the target value again from top to bottom. This happens at the determined air mass flow for the target value of the short-circuit current.

The electric current or the short-circuit current can in this case be controlled. Furthermore, the air mass flow can be controlled instead of the electrical current. The air compressor speed is adjusted as the control variable.

By means of the invention, the air mass flow can be adjusted with excess air when starting under freezing conditions, thereby achieving a more homogeneous air distribution among the cells and in the cells. As a result, several substantial advantages can be achieved:
1. Due to the more homogeneous air distribution, the cell voltages are more homogeneous. Adverse electrochemical reactions are absent or significantly reduced.
2. The availability of oxygen in the cells increases. The fuel cell reaction can take place anywhere. The risk of icing decreases.
3. The heat generated is better distributed in the cells. What are referred to as hot spots, as well as ice spots, are prevented or minimized.

Furthermore, it can be provided that the short-circuit current is monitored and in particular controlled when the method is performed. This can be advantageous for the system topologies having a current sensor in the electrical system, preferably in the short-circuit path of the electrical system.

If the short-circuit current is used as the control variable when increasing a rotational speed of a compressor, then it can be checked whether the short-circuit current has reached the desired target value from below.

If the short-circuit current is used as the control variable, when reducing the rotational speed of the compressor, it can be checked whether the short-circuit current has reached the desired target value from above.

Furthermore, it can, when the method is performed, be provided that the air mass flow in the cathode system of the stack is monitored and in particular controlled. This can be advantageous for the system topologies having an air mass flow sensor in a cathode system, preferably in the air intake path of the cathode system.

If the air mass flow is used as the control variable, increasing the rotational speed of the compressor until the short-circuit current exceeds the desired target value can be performed until the air mass flow in the cathode system of the stack increases to a second threshold value. If the second threshold value of the air mass flow is reached, it can be kept constant until the short-circuit current exceeds the target value. The short-circuit current can in this case be measured, calculated, and/or modulated.

If the air mass flow is used as the control variable, reducing the rotational speed of the compressor until the short-circuit current has reached the desired target value can be performed until the air mass flow in the cathode system of the stack reduces to a first threshold value. It is then assumed that the short-circuit current has reached the desired target value. This can also be checked by measuring the short-circuit current.

Advantageously, the second threshold value can be selected to be greater than the first threshold value for the air mass flow. In this way, the short-circuit current can be allowed to increase faster than if the air mass flow was kept at the first threshold value, which mathematically corresponds to the desired target value.

Furthermore, when increasing the rotational speed of the compressor until the short-circuit current exceeds the desired target value, it can be provided that the air mass flow in the cathode system of the stack does not exceed a second threshold value. In this way, an upper limit or a maximum threshold value for the air mass flow can be determined. This maximum threshold value can be selected to limit the short-circuit current from above.

Finally, it can be provided that the method can have at least one of the following actions:
checking whether the short-circuit current has reached the desired target value,
terminating the start under freezing conditions.

If the short-circuit current is used as the control variable, then the check of the short-circuit current can be performed as part of the control. If the air mass flow is used as the control variable, then the short-circuit current can be measured, calculated, and/or modulated separately to check the short-circuit current.

The method can also be performed at least in part by a control unit of the fuel cell system.

A corresponding control unit provides a further aspect of the invention. A computer program can be stored in a memory unit of the control unit in the form of a code which, when the code is executed by a computing unit of the control unit, performs a method that can proceed as described hereinabove. Using the control unit according to the invention, the same advantages can be achieved as described hereinabove in connection with the method according to the invention. In the present case, reference to these advantages is made in full.

The control unit can communicate with the sensors in the functional systems of the fuel cell system in order to monitor the sensor values.

The control unit can control the actuators in the functional systems of the fuel cell system, in particular a compressor in the cathode system of the fuel cell system in order to perform the method accordingly.

In addition, the control unit can be in a communication link with an external computing unit in order to outsource some method steps and/or calculations, in whole or part, to the external computing unit.

According to a further aspect, the invention provides a computer program product comprising instructions that, when the computer program is executed by a computer, e.g., the computing unit of the control unit, prompts the computer to perform the method, which can proceed as described hereinabove. Using the computer program product, the same advantages can be achieved as described above in connection with the method according to the invention and/or the control unit according to the invention. In the present case, reference to these advantages is made in full.

### BRIEF DESCRIPTION OF THE DRAWINGS

The invention and the embodiments, as well as the advantages thereof, are explained in further detail hereinafter with reference to the drawings. Schematically shown are:

FIG. 1 an exemplary fuel-cell system in the context of the invention,

FIG. 2 polarization curves at low temperatures,

FIG. 3 a chronological progression of a short-circuit with air depletion,

FIG. 4 a schematic sequence of a provided method, and

FIG. 5 a chronological progression of an operating strategy according to the invention.

In the various drawings, identical aspects of the invention are always indicated by identical reference characters, for which reason said parts are typically only described once.

### DETAILED DESCRIPTION

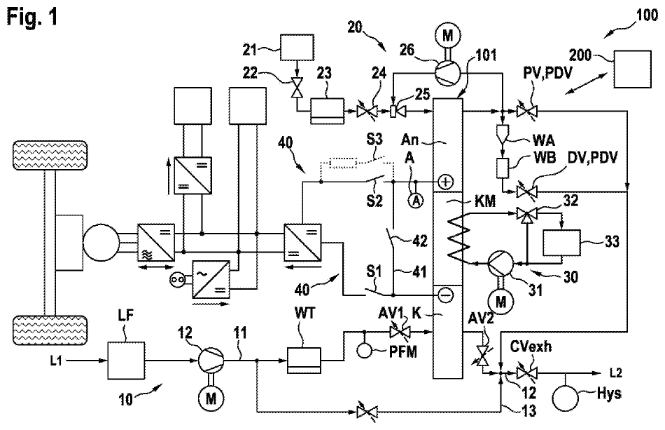

FIG. 1 shows an exemplary fuel cell system 100 within the scope of the invention. The fuel cell system 100 usually comprises multiple fuel cells, which are joined together to form a fuel cell stack 101. A cathode path K, an anode path An, and a path for a coolant KM are routed through the stack 101. The fuel cell system 100 can also be modular in design and comprise multiple stacks 101.

The fuel cell system 100 further comprises at least four functional systems 10, 20, 30, 40 including: a cathode system 10 to provide a cathode space or the cathode path K of the stack 101 with cathode air, usually simply compressed ambient air, or simply compressed air; an anode system 20 to provide an anode space or the anode path An of the stack 101 with a fuel, e.g. hydrogen H2; a cooling system 30 for tempering the stack 101; and an electrical system 40 for dissipating the generated electrical power from the stack 101 and supplying, for example, an electrical on-board power system of a vehicle F.

The fuel cell system 100 therefore comprises a cathode system 10 with a supply air line 11 to the stack 101 and an exhaust air line 12 from the stack 101. An air filter LF is usually arranged at the inlet of the supply air line 11 in order to filter harmful chemical substances and particles or to prevent their entry into the system 100. A compressor V in the cathode system 10 is used to draw in the air from the environment and supply it to the stack 101 in the form of supply air L1. After passing through the stack 101, an exhaust air L2 is discharged from the system 100 back into the environment U. As FIG. 1 indicates, at least one supply heat exchanger WT and optionally a humidifier (not shown) can be provided downstream of the compressor. Shut-off valves AV1, AV2 can be provided upstream and downstream of the stack 101. In addition, a valve CVexh can be provided as a pressure regulator in the exhaust air line 12. An air mass flow sensor PFM can be provided prior to entering the stack 101. After exiting the stack 101, in particular after the pressure regulator, a fuel sensor Hys can be provided. A bypass line 13 comprising a bypass valve 16 can be provided between the supply air line 11 and the exhaust air line 12.

The anode system 20 comprises multiple components. The components used to supply fuel include a fuel tank 21, a shut-off valve 22, and at least one pressure reduction valve 24. Optionally, a heat exchanger 23 can be provided in the anode system 20 downstream of the shut-off valve 22. Further components in the anode system 20, which cause the anode gas to recirculate in the anode circuit, are a jet pump 25 and a recirculation fan 26. In addition, a purge valve PV, and/or a drain valve DV, and/or a combined purge/drain valve PDV can be provided in the anode system 20. In addition, a water separator WA and optionally a water tank WB can be provided in the anode system 20.

The coolant system 30 comprises a coolant circuit, in which a coolant is recirculated with the aid of a coolant pump 31. A 3-way valve 32 can direct the coolant via a bypass at least partially or completely past a vehicle cooling means 33.

The electrical system 40 can comprise a short-circuit path 41 with a short-circuit relay 42. Advantageously, a current sensor A can be provided in the short-circuit path 41. The electrical system 40 can further comprise at least one pre-charge contactor S1, S2 and optionally a pre-charge contactor S3 comprising a pre-charge resistor.

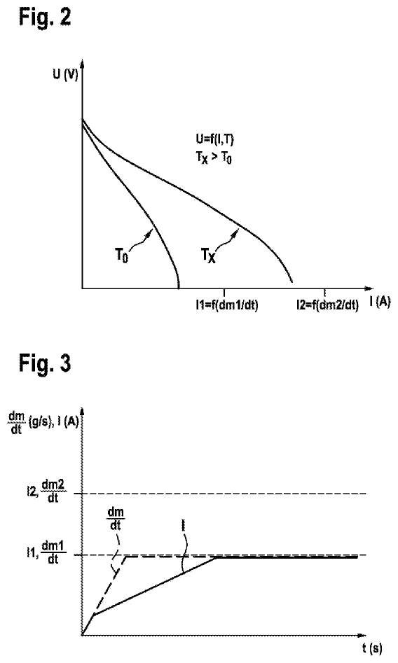

FIG. 2 schematically shows two polarization curves f(I, T)=U for the stack 101, in particular at low temperatures T, which prevail when starting under freezing conditions and which can be well below −4° C. The first progression at a temperature T₀ is quite steep and represents a typical path at very low temperatures T (e.g., −20° C.). The second progression at a temperature Tx is no longer as steep as the temperature Tx is >T₀.

In the case of a short-circuit, the electrical current I or the short-circuit current I is directly proportional to the air mass flow or oxygen mass flow:

$$I = \frac{\frac{dm / dt}{M} 4 F}{n} ,$$

whereby dm/dt is the oxygen mass flow, M is the molar mass of oxygen, F is the Faraday constant and n is the number of cells.

On the polarization curve, the short-circuit current I can be found on the 0-Achse, i.e. at the voltage U=0 V. In FIG. 2, the maximum short-circuit currents I1 and 12 are shown, which can be achieved with an air mass flow dm1/dt or dm2/dt. The actual short-circuit current I can optionally be lower (I<I1 or I<I2) when the temperature T of the stack 101 is in the freezing range such that the polarization curve f(I, T)=U is very steep.

For example, a specific air mass flow dm1/dt is set, but the fuel cell temperature T is T₀. The short-circuit current I will then occupy the intersection of the polarization curve f(I, T)=U with the x-axis, which lies before I1, i.e., I<I1.

While the temperature T of the stack 101 increases as the reaction progresses, the polarization curve f(I, T)=U flattens. This increases the short-circuit current I to I1.

If the temperature T of the stack 101 is increased further, the short-circuit current I remains at the target value I1 due to the limited supply of air mass flow at dm1/dt. The corresponding chronological progression is shown schematically in FIG. 3.

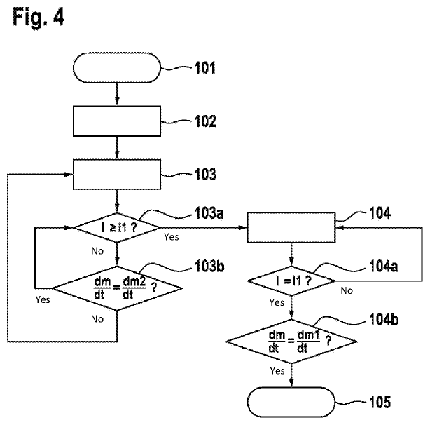

An exemplary sequence of a method within the meaning of the invention is shown in FIG. 4, which illustrates a method for operating a fuel cell system comprising at least one stack when starting the fuel cell system, in particular when starting the fuel cell system under freezing conditions in order to bring a short-circuit through the stack to a desired target value.

The method comprises the following actions:
101 initiating a start under freezing conditions,
102 short-circuiting the stack 101,
103 increasing a rotational speed N of a compressor 12 in a cathode system 10 of the stack 101 until the short-circuit current I (meaning the electrical current through the stack in the event of a short circuit of the stack) has exceeded the desired target value I1,
whereby during the increase of the rotational speed N of the compressor 12, an excess of air mass flow (dm2/dt-dm1/dt) is permitted in a targeted manner,
whereby, in particular with the permitted excess of air mass flow (dm2/dt-dm1/dt) and at consistent ambient conditions, in particular at a consistent temperature T, a higher value I2 of the short-circuit current I could be achieved than the desired target value I1,
104 reducing the rotational speed N of the compressor 12 until the short-circuit current I has reached the desired target value I1,
whereby during the reduction of the rotational speed N of the compressor 12, the excess of air mass flow (dm2/dt-dm1/dt) is reduced,
whereby in particular such an air mass flow dm1/dt is readjusted, which corresponds to the desired target value I1 of the short-circuit current I under consistent ambient conditions, in particular at a consistent temperature T.

The invention proposes to use the effect illustrated in FIG. 3 and explained in reference to FIG. 2. The effect is that the short-circuit current I increases somewhat more slowly at low temperatures T than the air mass flow dm/dt. If the air mass flow dm/dt has already reached the determined value dm1/dt, the short-circuit current I increases with a time delay caused by the low temperatures T until it reaches the desired target value I1.

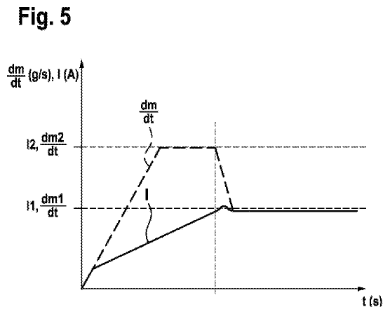

As FIG. 5 illustrates, the concept of the invention lies in the fact that the air mass flow dm/dt can initially be set higher (see value dm2/dt in FIG. 5) than the determined air mass flow (see the value dm1/dt in FIG. 5) for the desired target value I1 of the short-circuit current I so that excess air can be provided. The air mass flow dm/dt can then be lowered again from the higher value am2/dt to the determined air mass flow dm1/dt which is lower and the short-circuit current I can then be set to the desired target value I1.

In the proposed method, regulation of the electric current I or the short-circuit current I can be performed in a controlled manner. The short-circuit current I can be monitored (see actions 103a and 104a in FIG. 4) and controlled in the context of actions 103, 104. This may be advantageous for the system topologies having a current sensor A in the electrical system 40, preferably in the short-circuit path 41 of the electrical system 40.

If the short current I is used as the control variable, then an action 103a can be performed after the action 103 to check whether the short-circuit current I has reached the desired target value I1 from below.

If the short current I is used as the control variable, then an action 104a can be performed after the action 104 to check whether the short-circuit current I has reached the desired target value I1 from below.

Furthermore, the air mass flow dm/dt can be controlled instead of the electrical current I. In this case, the air mass flow dm/dt in the cathode system 10 of the stack 101 can be monitored (see the actions 103b and 104b in FIG. 4) and controlled within the meaning of the actions 103, 104. This may be advantageous for system topologies having an air mass flow sensor PFM in a cathode system 10, preferably in the air intake path 11 of the cathode system 10.

When the air mass flow dm/dt is used as the control variable, increasing the speed N of the compressor 12 for the action 103 can be performed until the air mass flow dm/dt in the cathode system 10 of the stack 101 increases to a second threshold value dm2/dt (see action 103b in FIG. 4). When the second threshold value dm2/dt of the air mass flow dm/dt is reached, it can be kept constant until the short-circuit current I exceeds the target value I1. The short-circuit current I1 can be measured, calculated and/or determined on a model basis (see action 103a in FIG. 4). The constant holding can, e.g., occur for a given time t, which can be determined according to FIGS. 2 and 5.

When the air mass flow dm/dt is used as the control variable, reducing the speed N of the compressor 12 for the action 104 can be performed until the air mass flow dm/dt in the cathode system 10 of the stack 101 decreases to a first threshold value dm1/dt (see action 104b in FIG. 4). It is then assumed that the short-circuit current I has reached the desired target value I1. This can also be checked by measuring the short-circuit current I (see action 104a in FIG. 4).

The speed of the compressor V can be adjusted as the control variable.

By means of the invention, the air mass flow dm/dt can be adjusted with excess air when starting under freezing conditions, thereby achieving a more homogeneous air distribution among the cells in stack 101 and in the cells themselves. As a result, the cell voltages are able to be distributed in a more homogeneous manner. Adverse electrochemical reactions are therefore absent or significantly reduced. As a result, the availability of oxygen in the cells can further be increased. The fuel cell reaction can take place anywhere. The risk of icing is reduced in this manner. In addition, the heat generated can thereby be better distributed in the cells. What are referred to as hot spots, as well as ice spots, are thus prevented or minimized.

As illustrated in FIG. 5, the second threshold value dm2/dt can be selected greater than the first threshold value dm1/dt for the air mass flow dm/dt.

As also indicated in FIG. 4, when increasing the speed N of compressor 12 for the action 103, it can further be checked whether the air mass flow rate dm/dt in the cathode system 10 of the stack 101 does not exceed a second threshold value dm2/dt (see action 103b in FIG. 4).

As further indicated in FIG. 4, the method can comprise at least one of the following actions:
104a checking whether the short-circuit current (I) has reached the desired target value (I1),
105 terminating the start under freezing conditions.

A corresponding control unit 200, which is schematically indicated in FIG. 1, provides a further aspect of the invention. A computer program in the form of code can be stored in a storage unit of the control unit 200 which, when the code is executed by a computing unit of the control unit 200, performs a method which can proceed as described hereinabove.

The control unit 200 can be communicatively connected to the sensors in the functional systems of the fuel cell system 100, in particular to the current sensor A in the electrical system 40 and/or to the air mass flow sensor PFM in the cathode system 10, to monitor the sensor values.

The control unit 200 can control the actuators in the functional systems 10, 20, 30, 40 of the fuel cell system 100, in particular the compressor V in the cathode system 10, accordingly in order to perform the method as described hereinabove.

Optionally, the control unit 200 can be in a communication connection with an external computing unit in order to outsource some method steps and/or calculations in whole or in part to the external computing unit.

The description hereinabove of the drawings merely describes the present invention by way of example. Of course, individual features of the embodiments can be freely combined with one another, insofar as technically sensible, without leaving the scope of the invention.

1. A method for operating a fuel cell system (100) comprising at least one stack (101) when starting the fuel cell system (100) under freezing conditions, in order to bring a short-circuit current (I) through the stack (101) to a desired target value (I1),
comprising the following steps:
initiating a start under freezing conditions,
short-circuiting the stack (101),
increasing a rotational speed (N) of a compressor (12) in a cathode system (10) of the stack (101) until the short-circuit current (I) has exceeded the desired target value (I1), wherein, during the increase of the rotational speed (N) of the compressor (12), an excess of air mass flow (dm2/dt−dm1/dt) is permitted in a targeted manner, and
reducing the rotational speed (N) of the compressor (12) until the short-circuit current (I) has reached the desired target value (I1), wherein, during the reduction of the rotational speed (N) of the compressor (12), the excess of air mass flow (dm2/dt−dm1/dt) is reduced.

2. The method according to claim 1,
wherein
the short-circuit current (I) is controlled.

3. The method according to claim 1,
wherein
when the method is performed, the air mass flow (dm/dt) in the cathode system (10) of the stack (101) is controlled.

4. The method according to claim 2,
wherein
when a rotational speed (N) of a compressor (12) is increased, it is checked whether the short-circuit current (I) has reached the desired target value (I1) from below,
and/or, when a rotational speed (N) of a compressor (12) is reduced, it is checked whether the short-circuit current (I) has reached the desired target value (I1) from above,

5. The method according to claim 3,
wherein
increasing the rotational speed (N) of the compressor (12) is performed until the air mass flow (dm/dt) in the cathode system (10) of the stack (101) increases to a second threshold value (dm2/dt),
and/or reducing the rotational speed (N) of the compressor (12) is performed until the air mass flow (dm/dt) in the cathode system (10) of the stack (101) drops to a first threshold value (dm1/dt),

6. The method according to claim 5,
wherein
the second threshold value (dm2/dt) is greater than the first threshold value (dm1/dt) for air mass flow (dm/dt).

7. The method according to claim 1,
wherein,
when increasing the rotational speed (N) of the compressor (12) the short-circuit current (I) exceeds the desired target value (I1),
it is checked that the air mass flow (dm/dt) in the cathode system (10) of the stack (101) does not exceed a second threshold value (dm2/dt).

8. The method according to claim 1,
wherein
the method comprises at least one of the following actions:
checking whether the short-circuit current (I) has reached the desired target value (I1),
terminating the start under freezing conditions.

9. A control unit (200) comprising a memory unit, in which a code is stored, and a computing unit, wherein, when the code is executed by the computing unit, the method according to claim 1 is performed.

10. A non-transitory, computer-readable storage medium comprising commands that, when executed by a computer, prompt the latter to operate a fuel cell system (100) comprising at least one stack (101) when starting the fuel cell system (100) under freezing conditions, in order to bring a short-circuit current (I) through the stack (101) to a desired target value (I1), by
initiating a start under freezing conditions,
short-circuiting the stack (101),
increasing a rotational speed (N) of a compressor (12) in a cathode system (10) of the stack (101) until the short-circuit current (I) has exceeded the desired target value (I1), wherein, during the increase of the rotational speed (N) of the compressor (12), an excess of air mass flow (dm2/dt-dm1/dt) is permitted in a targeted manner, and
reducing the rotational speed (N) of the compressor (12) until the short-circuit current (I) has reached the desired target value (I1), wherein, during the reduction of the rotational speed (N) of the compressor (12), the excess of air mass flow (dm2/dt−dm1/dt) is reduced.
